(19) United States
(12) Patent Application Publication
(10) Pub. No.: US 2021/0273332 A1
(43) Pub. Date: Sep. 2, 2021

(54) ELECTROMAGNETIC WAVE CONTROL DEVICE

(71) Applicant: FUJITSU LIMITED, Kawasaki-shi (JP)

(72) Inventors: Yohei Koga, Yamato (JP); Yasumitsu BAN, Yamato (JP); Takashi YAMAGAJO, Yokosuka (JP); Manabu Yoshikawa, Yokohama (JP); HARUHIKO HORIZOE, Dazaifu (JP)

(73) Assignee: FUJITSU LIMITED, Kawasaki-shi (JP)

(21) Appl. No.: 17/322,991

(22) Filed: May 18, 2021

Related U.S. Application Data
(63) Continuation of application No. PCT/JP2018/046662, filed on Dec. 18, 2018.

(51) Int. Cl. H01Q 3/44; H01Q 15/14; H01Q 1/22

(52) U.S. Cl. CPC H01Q 3/44; H01Q 9/16; H01Q 1/2291; H01Q 15/14

(57) ABSTRACT

An electromagnetic wave control device that controls a directionality of radio waves emitted by an antenna, the electromagnetic wave control device includes: a reflector arranged on a side opposite to an emission side of the radio waves of the antenna; and a conductor plate that is arranged on the emission side of the radio waves of the antenna and on which a conductor is formed, wherein in the conductor plate, a plurality of holes formed by opening the conductor is provided in a grid pattern, and has an inner edge length with which the hole positioned at the center resonates in correspondence with one wavelength of a communication wavelength, and the inner edge length of the hole is formed to be longer as going outward from the center.

### CROSS-REFERENCE TO RELATED APPLICATION

This application is a continuation application of International Application PCT/JP2018/046662 filed on Dec. 18, 2018 and designated the U.S., the entire contents of which are incorporated herein by reference.

### FIELD

The embodiment discussed herein is related to an electromagnetic wave control device that controls electromagnetic waves.

### BACKGROUND

By installing an access point (AP) of a wireless LAN, a sensor, a terminal, or the like can wirelessly communicate with the AP. With widespread use of Internet Of Things (IoT) technology, there are increasing opportunities to wirelessly communicate data acquired by the sensor or the terminal via the APs.

International Publication Pamphlet No. WO 2006/004156 and Japanese Laid-open Patent Publication No. 2012-49779 are disclosed as related art.

### SUMMARY

According to an aspect of the embodiments, an electromagnetic wave control device that controls a directionality of radio waves emitted by an antenna, the electromagnetic wave control device includes: a reflector arranged on a side opposite to an emission side of the radio waves of the antenna; and a conductor plate that is arranged on the emission side of the radio waves of the antenna and on which a conductor is formed, wherein in the conductor plate, a plurality of holes formed by opening the conductor is provided in a grid pattern, and has an inner edge length with which the hole positioned at the center resonates in correspondence with one wavelength of a communication wavelength, and the inner edge length of the hole is formed to be longer as going outward from the center.

The object and advantages of the invention will be realized and attained by means of the elements and combinations particularly pointed out in the claims.

It is to be understood that both the foregoing general description and the following detailed description are exemplary and explanatory and are not restrictive of the Invention.

### BRIEF DESCRIPTION OF DRAWINGS

FIG. 1 is a diagram illustrating an electromagnetic wave control device according to an embodiment;

FIG. 2 is a diagram illustrating an installation example of the electromagnetic wave control device according to the embodiment;

FIG. 3 is a diagram illustrating a hardware configuration example of an electromagnetic device according to the embodiment;

FIGS. 4A and 4B are a diagram for explaining a control state of a directionality by the electromagnetic wave control device according to the embodiment (Part 1);

FIGS. 5A and 5B are a diagram for explaining the control state of the directionality by the electromagnetic wave control device according to the embodiment (Part 2);

FIGS. 6A and 6B are a diagram for explaining the control state of the directionality by the electromagnetic wave control device according to the embodiment (Part 3);

FIGS. 7A and 7B are a diagram for explaining the control state of the directionality by the electromagnetic wave control device according to the embodiment (Part 4);

FIGS. 8A and 88 are a diagram for explaining the control state of the directionality by the electromagnetic wave control device according to the embodiment (Part 5);

FIGS. 9A and 9B are a diagram for explaining the control state of the directionality by the electromagnetic wave control device according to the embodiment (Part 6);

FIG. 10 is a diagram for explaining control of the directionality by the electromagnetic wave control device according to the embodiment (Part 1);

FIG. 11 is a diagram for explaining the control of the directionality by the electromagnetic wave control device according to the embodiment (Part 2);

FIG. 12 is a diagram illustrating a switch drive line example of the electromagnetic wave control device according to the embodiment;

FIGS. 13A to 13E are a diagram illustrating an example of a change in a size of a hole formed in a conductive plate of the electromagnetic wave control device according to the embodiment;

FIG. 14 is a table illustrating a change in characteristics at the time when the size of the hole formed in the conductive plate of the electromagnetic wave control device according to the embodiment is changed;

FIG. 15A is a diagram illustrating simulation results of various characteristics at the time when the hole of the electromagnetic wave control device according to the embodiment is set according to a pattern 2 that is a reference (Part 1);

FIG. 15B is a diagram illustrating simulation results of various characteristics at the time when the hole of the electromagnetic wave control device according to the embodiment is set according to the pattern 2 that is a reference (Part 2);

FIG. 15C is a diagram illustrating simulation results of various characteristics at the time when the hole of the electromagnetic wave control device according to the embodiment is set according to the pattern 2 that is a reference (Part 3);

FIG. 16 is a diagram illustrating a simulation result of a directionality at the time when the hole of the electromagnetic wave control device according to the embodiment is set according to a pattern 5;

FIGS. 17A to 17F are a diagram illustrating various examples of arrangement of the holes of the electromagnetic wave control device according to the embodiment;

FIG. 18A is a diagram illustrating various characteristics corresponding to the various examples of the arrangement of the holes of the electromagnetic wave control device according to the embodiment (Part 1);

FIG. 18B is a diagram illustrating various characteristics corresponding to the various examples of the arrangement of the holes of the electromagnetic wave control device according to the embodiment (Part 2);

FIG. 18C is a diagram illustrating various characteristics corresponding to the various examples of the arrangement of the holes of the electromagnetic wave control device according to the embodiment (Part 3);

FIG. 19 is a diagram illustrating a modification of a switch of the electromagnetic wave control device according to the embodiment; and

FIG. 20 is a diagram for explaining an application example of the electromagnetic wave control device according to the embodiment.

### DESCRIPTION OF EMBODIMENTS

Because radio waves annularly spread toward a communication area, a dipole antenna that is mainly used for the APs cannot control a directionality of the radio waves due to leakage of extra radio waves to the outside of a desired area, an interference with radio waves of an adjacent AP, reflected waves of a wall, or a metal surface, or the like.

There is a technology for providing a plurality of conductor elements in a grid pattern on a rear surface of a patch antenna and providing a connection element that electrically connects the conductor elements so as to control the directionality. Furthermore, there is a technology of an antenna that includes cycle loop structures arranged like a plurality of loop element matrix on a reflector and an exciting element and has a predetermined directionality.

However, it has not been possible to control a directionality of radio waves emitted from an antenna (dipole antenna) of an AP or an existing wireless router. Since an antenna is integrated with a radiator, it is not possible to control a directionality with respect to radio waves emitted by a general-purpose antenna.

Furthermore, flexibly coping with a change in the radio wave environment may be not performed, and this may affect site operations. For example, there is a case where APs may be, for example, added for each department within a predetermined region coping with expansion of the departments for improvement in the site operations in factories, offices, or the like. In this case, it is not possible to change a range where radio waves of each AP reach, and a problem occurs in that radio wave interference occurs between the APs and data lacks, for example.

For example, a structure in which each antenna has a fixed directionality may be provided, and a work such as to change an angle of the antenna has been required in order to change the directionality after installation. In addition, it has not been possible to perform control to change the directionality to an optional direction in a state where the antenna is fixed and arranged.

According to one aspect, a directionality of radio waves emitted by an antenna may be controlled.[0013] (Embodiment)

Hereinafter, an embodiment of an electromagnetic wave control device will be described. The electromagnetic wave control device according to the embodiment is provided in an emission direction of radio waves emitted by an antenna (dipole antenna) and controls a directionality of the radio waves.

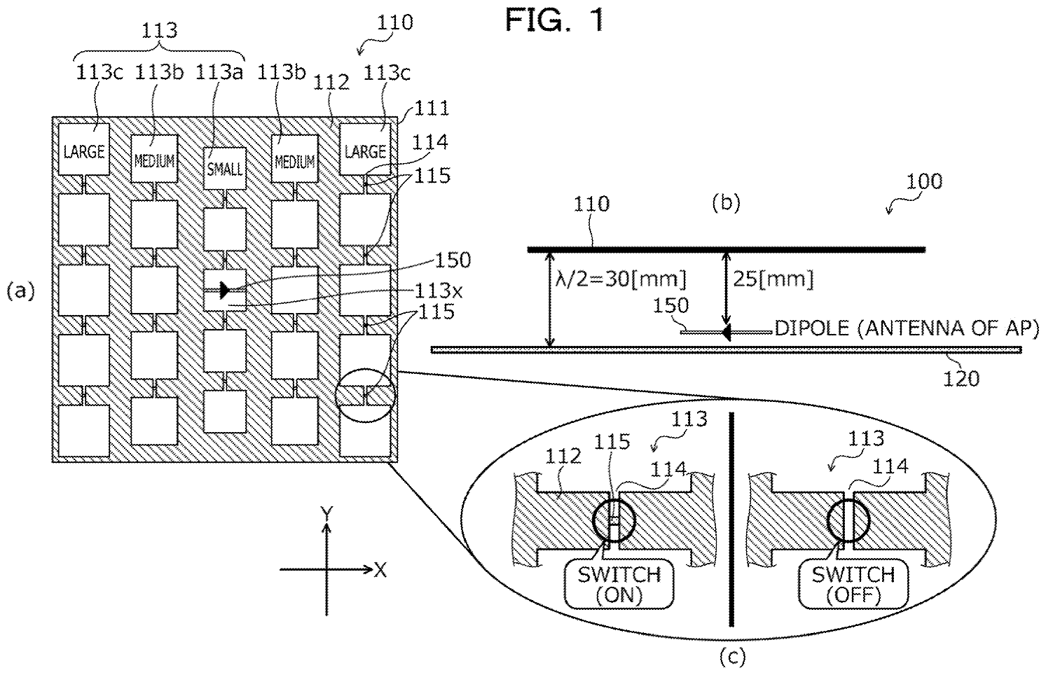

FIG. 1 is a diagram illustrating an electromagnetic wave control device according to the embodiment. FIG. 1(a) is a front view, FIG. 1(b) is a side view, and FIG. 1(c) is a partially enlarged view of FIG. 1(a).

As illustrated in FIG. 1(b), an electromagnetic wave control device 100 includes a conductive plate 110, a reflector 120, and a dipole antenna (antenna of AP) 150 arranged between the conductive plate 110 and the reflector 120. The dipole antenna 150 is an antenna included in a general-purpose AP. The radio wave (electromagnetic wave) emitted from the dipole antenna 150 is reflected by the reflector 120 arranged on the side opposite to the emission side of the radio waves of the dipole antenna 150, and is emitted to the outside through the conductive plate 110.

As illustrated in FIG. 1(a), the conductive plate 110 can be formed, for example, by pattern forming a metal conductor 112 on a printed circuit board 111 that includes a dielectric and has a plurality of holes (opening) 113. The hole 113 is formed in a square shape, corresponds to a part of the conductor 112 where a pattern Is not formed, and transmits the radio waves emitted by the dipole antenna 150. Furthermore, the hole 113 may be provided so as to pass through the printed circuit board 111.

The holes 113 are arranged in a grid pattern having n rows×m columns on the printed circuit board 111. A length of an entire inner periphery (inner edge length) of a hole 113a at the center of a column m has a length of about one wavelength λ (for example, λ=60 mm) of a communication wavelength. Furthermore, inner edge lengths of holes 113b and 113c outer side of the hole 113a at the center of the column m in the column direction are formed to be gradually longer than one wavelength as going outward.

In the example in FIG. 1(a), the hole 113a, in the n row, that is positioned at the center in the column direction has the smallest inner edge length and has a length of about one wavelength of the communication wavelength. The hole 113b on the outer side in the column direction than the hole 113a at the center of the column m is formed to have an inner edge length longer (medium) than the hole 113a. The hole 113c on the outer side of the hole 113b in the column direction is formed to have an inner edge length longer than the hole 113b. As a result, an opening size (opening size) of the hole 113a at the center is the smallest (small), the hole 113b has a larger opening size (medium) than the hole 113a, and the hole 113c has the largest opening size (large).

Furthermore, a slit 114 that connects between a pair of adjacent holes 113 is provided between the adjacent holes 113. In the example in FIG. 1(a), the holes 113 in one column in the vertical direction are connected each other with the slit 114. The slit 114 is also a part where the pattern of the conductor 112 is not formed similarly to the holes 113.

The dipole antenna 150 is arranged in a hole 113x portion positioned at the center of the holes 113 in n rows×m columns. A direction of a main polarized wave of the dipole antenna 150 is an X axis (horizontal axis) direction in the drawing. In this case, the slit 114 is provided in a Y axis direction orthogonal to the direction of the main polarized wave of the dipole antenna 150. In other words, for example, as illustrated in FIG. 1(a), the slit 114 is arranged between the holes 113 adjacent to each other in the vertical direction, that is, the Y axis direction.

Furthermore, as illustrated in FIG. 1(c), a switch (SW) 115 is provided in each slit 114 portion. The switch 115 switches connection between the adjacent holes 113 by an ON/OFF switching operation. At the time when the switch 115 is turned ON, the conductors 112 in the slit 114 portion are conductively connected to each other. As a result, the conductors 112 in outer peripheral portions of the adjacent holes 113 are conductively connected to each other. The hole 113a formed by turning ON the switch 115 has an inner edge length of about one wavelength (λ) and is in a resonance state to which a current is applied. Although each of the holes 113b and 113c also has an inner edge length longer than one wavelength (λ), the holes 113b and 113c are similarly in a resonance state to which a current is applied.

On the other hand, at the time when the switch 115 is turned OFF, the conductors 112 in the slit 114 portion are disconnected to each other. As a result, the adjacent holes 113 are in a disconnected state. Because the hole 113a is connected to the adjacent hole 113a by turning OFF this switch 115, the inner edge length of the plurality of holes 113a is largely longer than one wavelength, and the holes 113a are in a non-resonance state. Similarly, the holes 113b and 113c are sufficiently larger than one wavelength and are in a non-resonance state. In this case, the directionality with respect to the radio waves is not controlled.

It is desirable that all the lengths (length in Y axis direction) of the respective slits 114 be the same length. This is because, at the time when the switch 115 is turned ON, the slit 114 portion is also included as the inner edge length formed by one hole 113. In other words, for example, strictly, at the time when the switch 115 is turned ON, the size of the hole 113 is set so that the inner edge length of the hole 113 including one slit 114 portion is about one wavelength.

A control unit to be described later connects between optional adjacent holes 113 by performing switching control for individually turning ON/OFF each switch 115. By connecting between the optional adjacent holes 113, a plurality of patterns in which the adjacent holes 113 are connected can be obtained. The control unit controls a directionality of the radio waves emitted by the antenna 150 by controlling switching of the switch 115 corresponding to each pattern of the plurality of directionalities.

A dimensional example of each unit of the electromagnetic wave control device 100 illustrated in FIG. 1 is illustrated. An overall size of the conductive plate 110 is 120 mm in length×120 mm in width, and the smallest hole 113a (small) has a size of 14.4 mm in length×14.4 mm in width. A distance between the conductive plate 110 and the reflector 120 is λ/2=30 mm. It is sufficient that the antenna 150 be arranged between the conductive plate 110 and the reflector 120, and in the example in FIG. 1(b), the antenna 150 is arranged at a position 25 mm away from the conductive plate 110.

Furthermore, the slit 114 illustrated in FIG. 1 is provided at the center position of the vertically adjacent holes 113. However, the position of the slit 114 is not limited to this. For example, it is sufficient that the slit 114 connect the vertically adjacent holes 113, and the slit 114 may be provided at a position other than the center position of the holes 113, for example, a position displaced in the column direction. Furthermore, the slit 114 is not limited to be linearly provided between the vertically adjacent holes 113 and may be provided diagonally or in a zigzag manner.

Furthermore, the hole 113 illustrated in FIG. 1 has a square shape. However, the shape is not limited to this, and the hole 113 may have a circular shape or a polygonal shape. At this time, it is sufficient that the inner edge length of the smallest hole 113a be set to about one wavelength.

Furthermore, in the embodiment, as the antenna, the dipole antenna 150 is used as an example. However, the antenna is not limited to this, and may be, for example, a flat patch antenna or the like.

Furthermore, in the embodiment, an example will be described in which one conductive plate 110 is used. However, the number of conductive plates 110 is not limited to this, and two or more conductive plates 110 may be stacked (slightly separated from each other) and arranged. By using the plurality of conductive plates 110, the directionality can be controlled more sharply.

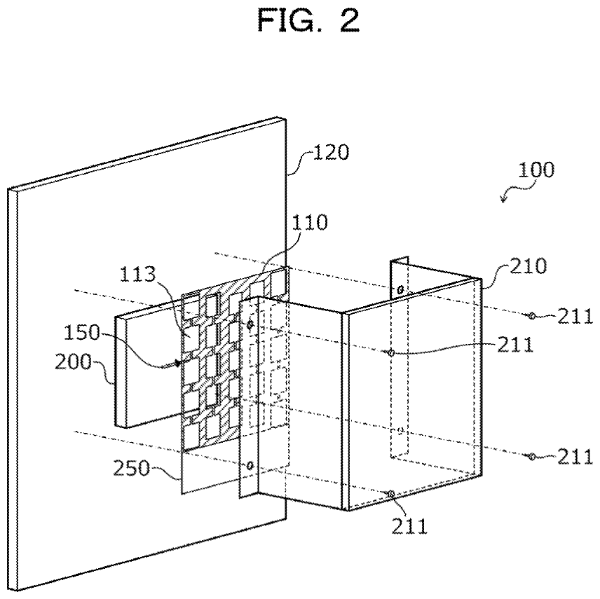

FIG. 2 is a diagram illustrating an installation example of the electromagnetic wave control device according to the embodiment. A configuration example in FIG. 2 illustrates a configuration example including an access point (AP) 200 as the electromagnetic wave control device 100. The AP 200 indicates a housing (case) of an entire device of a general-purpose wireless router or a wireless LAN and includes the dipole antenna 150 described above in the case. The conductive plate 110 described above is arranged on a front surface (radio wave emission side) of the AP 200, and the reflector 120 described above is arranged on a rear surface (opposite side of radio wave emission side) of the AP 200. The reflector 120 is attached to a wall, a ceiling, or the like.

Then, a cover 210, which transmits radio waves, made of resin or the like is provided to the front side of the conductive plate 110. The cover 210 is attached to the reflector 120 with screws 211. The cover 210 contains the conductive plate 110 and the AP 200 therein and protects the conductive plate 110 and the AP 200. A reference numeral 250 indicates a control unit and controls the directionality of the radio waves by controlling switching of the switch 115 of the conductive plate 110. For example, as illustrated in FIG. 2, the control unit 250 is provided adjacent part to the conductive plate 110 on the printed circuit board 111 and mounts each electronic component included in the control unit 250. Without limitation to this, the control unit 250 may be arranged at another place using the conductive plate 110 and another printed circuit board.

In this way, the electromagnetic wave control device 100 may have a configuration that incorporates and is integrated with the general-purpose AP 200. Without limitation to this, a configuration may be used in which only the antenna (dipole antenna) 150 is extracted from the overall configuration of the general-purpose AP 200 and the antenna 150 is arranged between the conductive plate 110 and the reflector 120 as illustrated in FIG. 1.

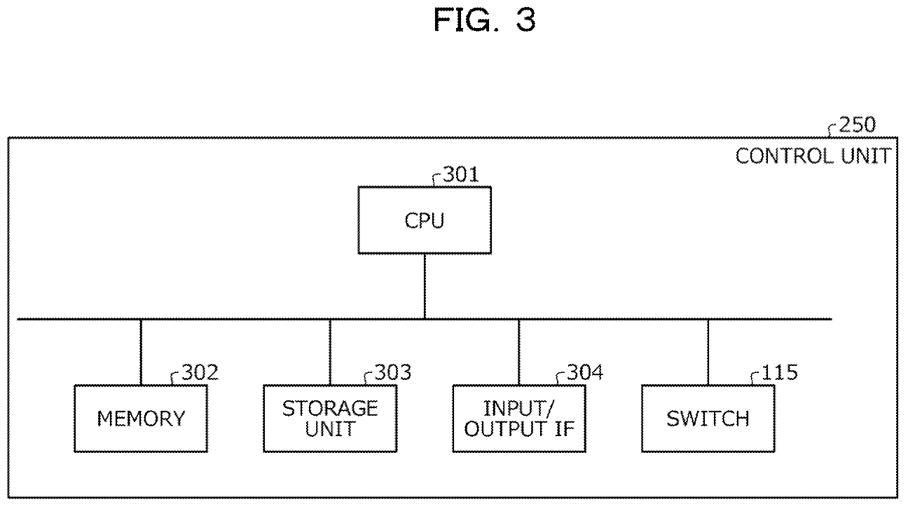

FIG. 3 is a diagram illustrating a hardware configuration example of an electromagnetic device according to the embodiment. A configuration example of the control unit 250 of the electromagnetic wave control device 100 is illustrated. The control unit 250 includes a CPU 301, a memory 302, a storage unit 303, and an input/output interface (IF) 304.

The CPU 301 executes control programs stored in the memory 302 and the storage unit 303, controls the electromagnetic wave control device 100, and at this time, uses the memory 302 such as a RAM as a work area. The storage unit 303 includes, for example, a ROM, a flash memory, or the like and holds various types of information such as a control program, setting data, or a control state. The input/output IF 304 is an interface to perform operation setting on the directionality by a user.

The CPU 301 controls switching of the corresponding switch 115 on the basis of the operation setting on the directionality by the user, for example. At this time, a controllable directionality pattern is displayed to the user via a display unit (not illustrated), and the CPU 301 can control switching of the switch 115 in correspondence with the pattern of the directionality selected by the user. The switching control of the switch 115 can be held, for example, in the storage unit 303 as setting data in which a switching state of the switch 115 for each directionality is set. The CPU 301 can read a switching pattern of each switch 115 corresponding to the directionality selected by the user.

(Directionality Control Simulation)

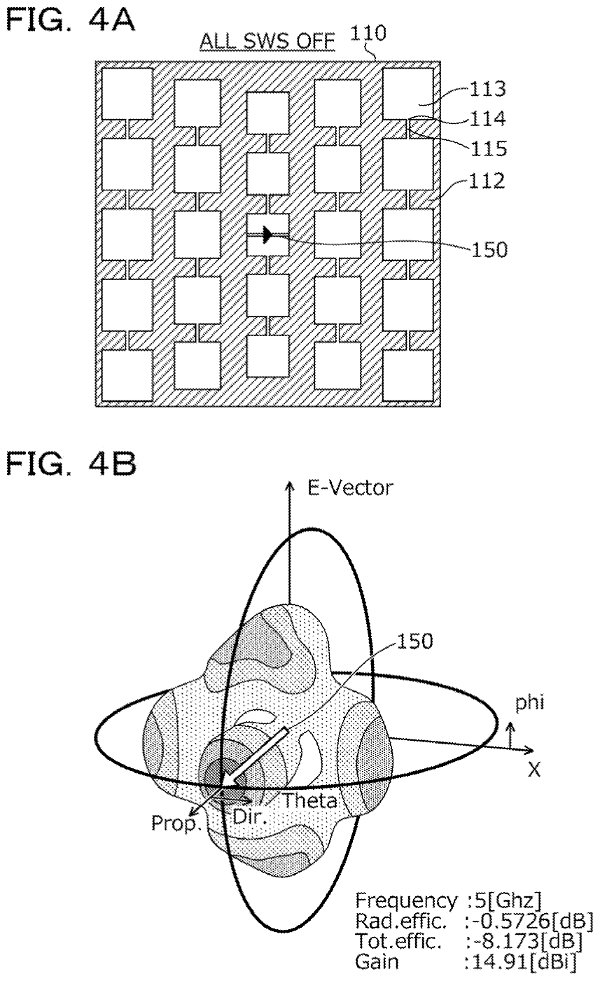

FIGS. 4 to 9 are diagrams for explaining a control state of the directionality by the electromagnetic wave control device according to the embodiment. A simulation result regarding an electric field strength (directionality) obtained by using an electromagnetic simulator is illustrated. In these drawings, it is assumed that a communication frequency be f=5 GHz (λ=60 mm). (a) in each drawing illustrates a connection state between the holes under the control of the switch 115 of the conductive plate 110 by the control unit 250, and (b) illustrates three-dimensional directional characteristics at that time.

1. All the Switches 115 are Turned OFF

FIGS. 4A and 4B illustrate a state where all the switches 115 are turned OFF. In this case, all the switches 115 illustrated in FIG. 4A are turned OFF, the adjacent holes 113 are connected to each other by the slit 114, and the conductive plate 110 does not control the directionality with respect to the radio waves emitted by the dipole antenna 150. Therefore, as illustrated in FIG. 4B, an electric field from the dipole antenna 150 portion toward a front-surface direction of the conductive plate 110 is strong, and the radio waves are emitted toward the front-surface direction. At this time, a conductor loss (Rad.effic.) is −0.5726 dB, a total efficiency (Tot.effic.) is −8.173 dB, and an absolute gain (Gain) is 14.91 dBi.

2. The Switches 115 on the Left Side are Turned ON

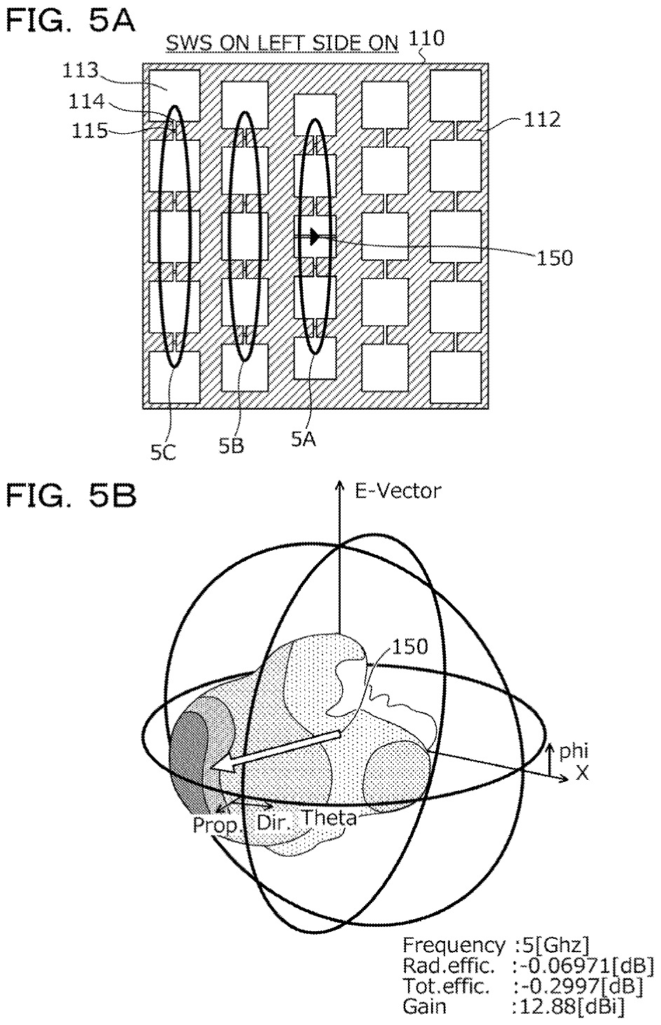

FIGS. 5A and 5B illustrate a state where the switches 115 on the left side are turned ON. In this case, as illustrated in FIG. 5A, all the switches 115 on the left side of the center column in the column direction of the conductive plate 110 are turned ON, and the holes 113 positioned in columns 5A, 5B, and 5C are connected in the column direction.

At this time, as illustrated in FIG. 5B, the conductive plate 110 emits the radio waves emitted by the dipole antenna 150 to the front side with a strong electric field on the left side and with a directionality on the left side. At this time, the conductor loss (Rad.effic.) is −0.06971 dB, the total efficiency (Tot.effic.) is −0.2997 dB, and the absolute gain (Gain) is 12.88 dBi. Furthermore, as in the example in FIGS. 5A and 5B, when the switches 115 on the right side are turned ON, the directionality on the right side is obtained.

3. The Switches 115 on the Lower Side are Turned ON

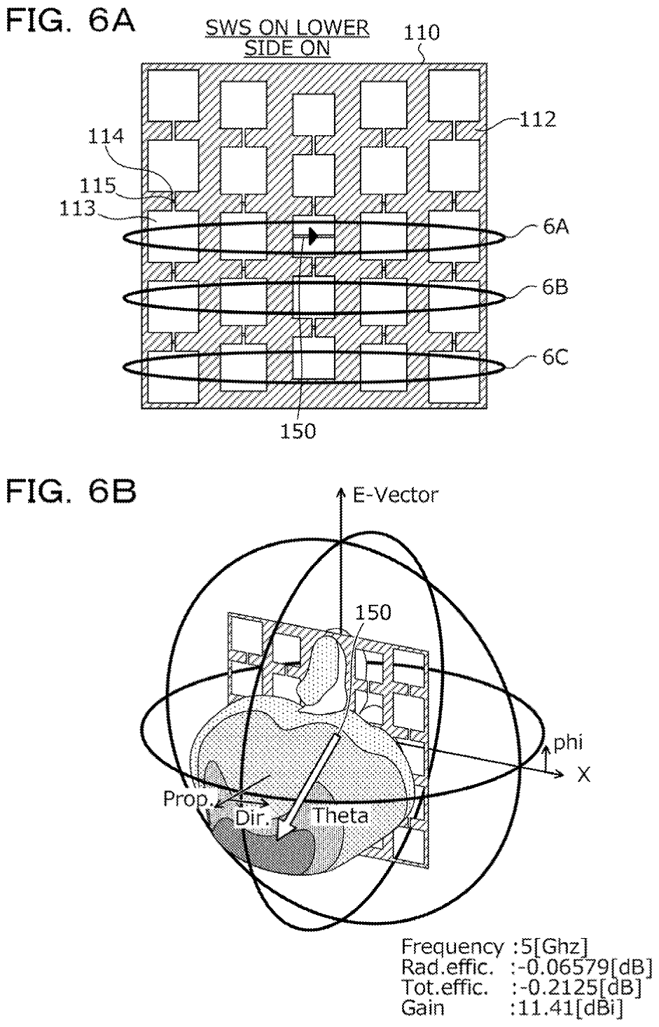

FIGS. 6A and 68 illustrate a state where the switches 115 on the lower side are turned ON. In this case, as illustrated in FIG. 6A, all the switches 115 on the lower side of the center column in the row direction of the conductive plate 110 are turned ON, and the holes 113 positioned in rows 6A, 68, and 6C are connected in the column direction.

At this time, as illustrated in FIG. 6B, the conductive plate 110 emits the radio waves emitted by the dipole antenna 150 to the front side with a strong electric field on the lower side and with a directionality on the lower side. At this time, the conductor loss (Rad.effic.) Is −0.06579 dB, the total efficiency (Tot.effic.) is −0.2125 dB, and the absolute gain (Gain) is 11.41 dBi. Furthermore, as in the example in FIGS. 6A and 68, when the switches 115 on the upper side are turned ON, the directionality on the upper side is obtained.

4. The Central Switches 115 Arranged in the Vertical Direction are Turned ON

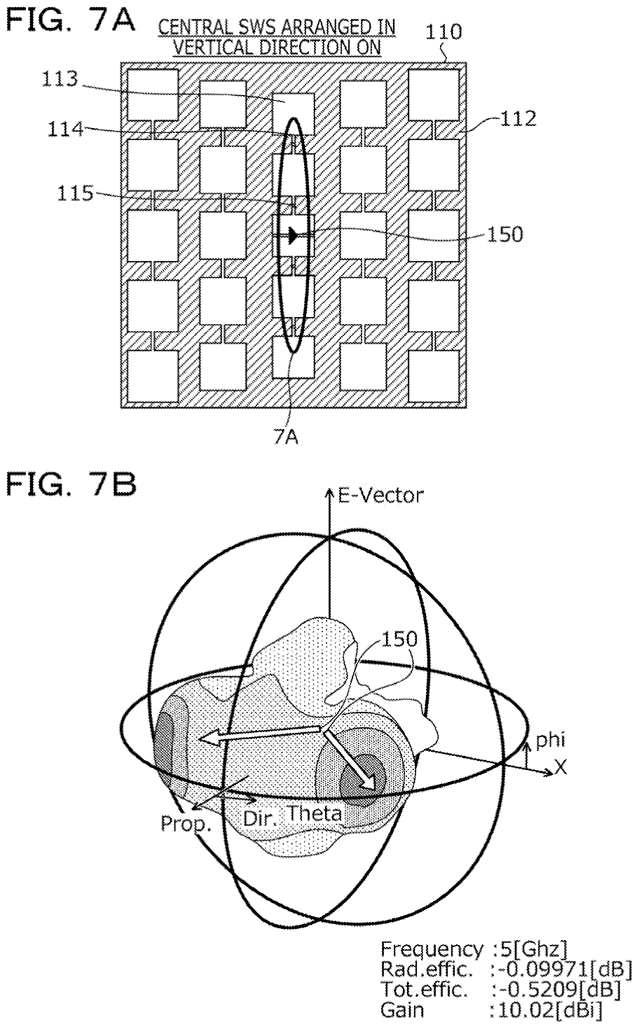

FIGS. 7A and 7B illustrate a state where the central switches 115 arranged in the vertical direction are turned ON. In this case, as illustrated in FIG. 7A, the switches 115 in one central column in the column direction of the conductive plate 110 are turned ON, and the holes 113 positioned in a column 7A are connected in the column direction.

At this time, in the simulation result, as illustrated in FIG. 7B, the conductive plate 110 emits the radio waves emitted by the dipole antenna 150 with a strong electric field branched into two directions, that is, the left and the right directions. At this time, the conductor loss (Rad.effic.) is −0.09971 dB, the total efficiency (Tot.effic.) is −0.5209 dB, and the absolute gain (Gain) is 10.02 dBi.

5. The Central Switches 115 Arranged in the Horizontal Direction are Turned ON

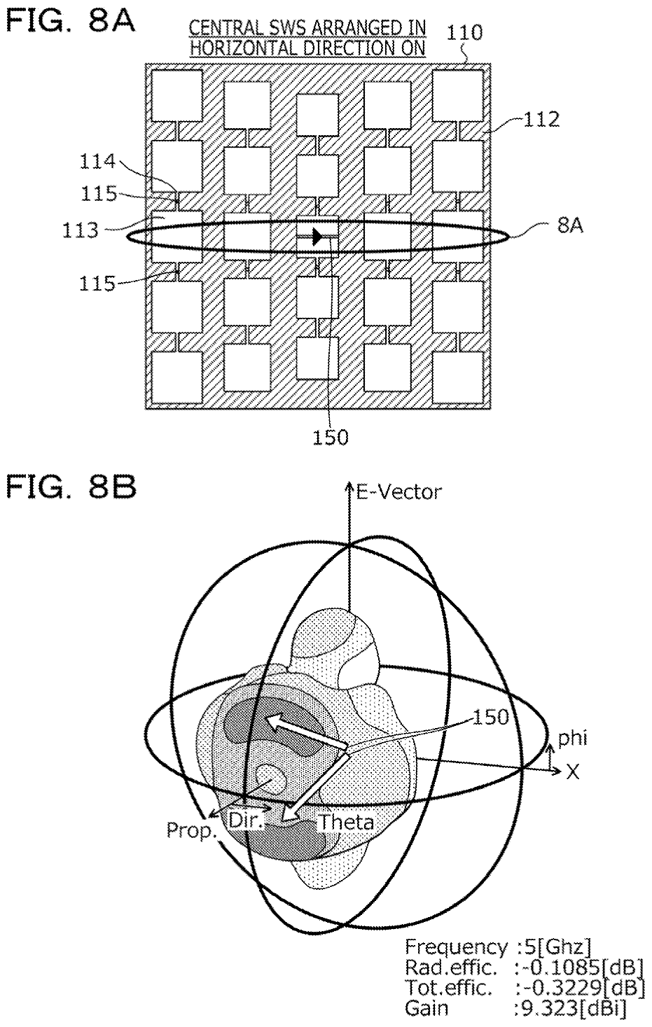

FIGS. 8A and 8B illustrate a state where the central switches 115 arranged in the horizontal direction are turned ON. In this case, as illustrated in FIG. 8A, the switches 115 positioned on the upper and lower sides of holes 113 positioned in a row 8A in the row direction of the conductive plate 110 are turned ON, and the holes 113 positioned in the row 8A are connected in the row direction.

At this time, in the simulation result, as illustrated in FIG. 8B, the conductive plate 110 emits the radio waves emitted by the dipole antenna 150 with a strong electric field branched into two directions, that is, the upper and the lower directions. At this time, the conductor loss (Rad.effic.) is −0.1085 dB, the total efficiency (Tot.effic.) is −0.3229 dB, and the absolute gain (Gain) is 9.323 dBi.

6. The Diagonally Lower Switches 115 are Turned ON

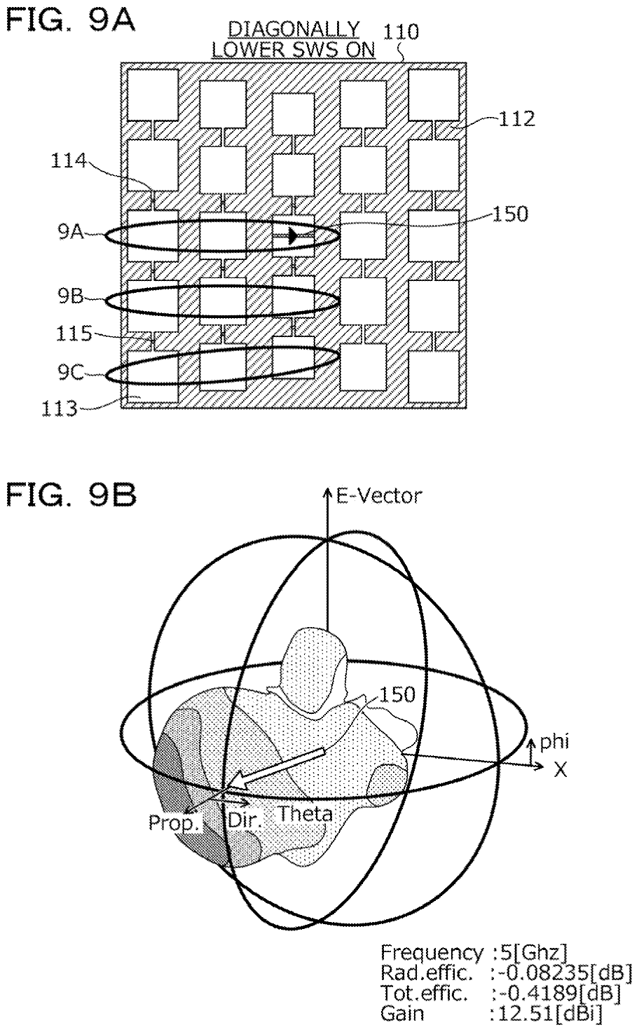

FIGS. 9A and 9B illustrate a state where the diagonally lower (lower left) switches 115 are turned ON. In this case, as illustrated in FIG. 9A, the switches 115 positioned diagonally lower than the center of the conductive plate 110 are turned ON, and the holes 113 on the left side of the center of rows 9A, 9B, and 9C are connected in the column direction.

At this time, in the simulation result, as illustrated in FIG. 9B, the conductive plate 110 emits the radio waves emitted by the dipole antenna 150 with a strong electric field in the diagonally lower left direction and with a directionality in the diagonally lower left direction. At this time, the conductor loss (Rad.effic.) is −0.08235 dB, the total efficiency (Tot.effic.) is −0.4189 dB, and the absolute gain (Gain) is 12.51 dBi. As in the example in FIGS. 9A and 9B, when the switches 115 on the upper left, upper right, and lower right sides are turned ON, similarly, directionalities in the upper left, upper right, and lower right sides are obtained.

As illustrated in FIGS. 4A to 91, with the control unit 250, the conductive plate 110 can control the direction (directionality) of the electric field of the radio waves emitted from the dipole antenna 150 to any direction corresponding to switching control of the switch 115 on the conductive plate 110.

By the way, the switches 115 arranged on the conductive plate 110 in the configuration described above are provided in the row direction of the adjacent holes 113. Therefore, for example, when one hole 113 on the upper left of the conductive plate 110 is selected, it is sufficient to perform switching control to turn ON a switch 115 positioned immediately below the one hole 113 on the upper left. Furthermore, when one hole 113 in the second row from the upper left of the conductive plate 110 is selected, it is sufficient to perform switching control to turn ON two switches 115 positioned on the upper and lower sides of the one hole 113 in the second row from the upper left.

Then, the number of holes 113 described as an example described above is 5 rows×5 columns=25, and this 25 holes 113 can be selected using the switches 115 (4 rows×5 columns=20) less than the holes 113.

Furthermore, in the above description, it is configured that the hole 113 is selected by controlling switching of the switch 115. However, it is possible to form the above-described states “2. The switches 115 on the left side are turned ON” to “6. The diagonally lower switches 115 are turned ON” without providing the switch 115. For example, a configuration corresponding to “2. The switches 115 on the left side are turned ON” is set to a configuration in which the conductor 112 connects between the adjacent holes 113 including a portion of a position of the switch 115. It is sufficient that each hole 113 have a closed shape with an inner edge length of about one wavelength. In this case, the electromagnetic wave control device 100 has characteristics of only a directionality fixed to any one of “2. The switches 115 on the left side are turned ON” to “6. The diagonally lower switches 115 are turned ON”. In this way, with the configuration in which the switch 115 is not provided, the electromagnetic wave control device 100 according to the embodiment can obtain a directionality to each direction with respect to the radio waves emitted by a general-purpose AP (dipole antenna 150) using this AP.

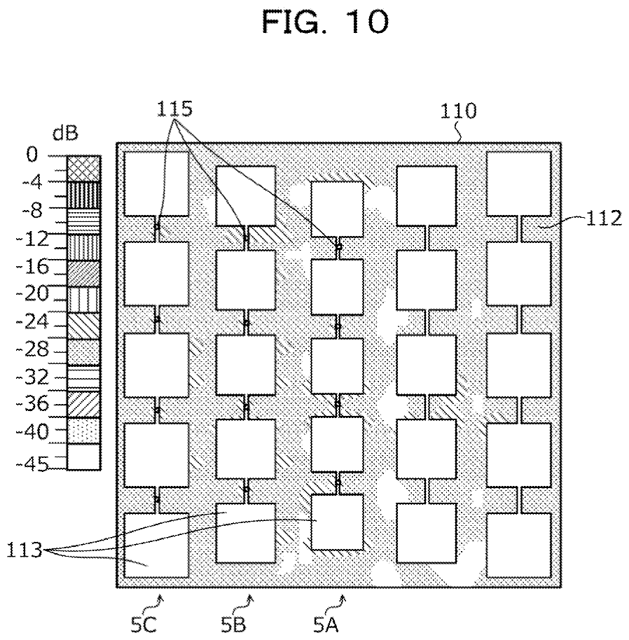

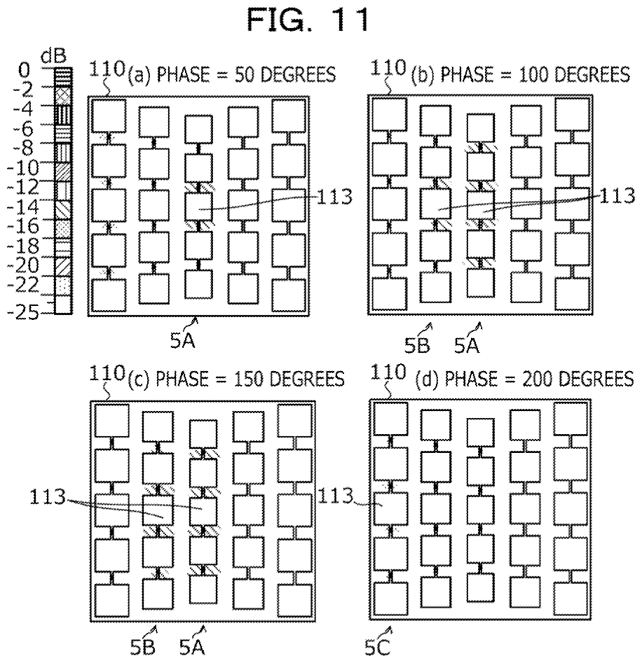

FIGS. 10 and 11 are diagrams for explaining control of the directionality by the electromagnetic wave control device according to the embodiment. In these drawings, a current distribution (absolute value) is illustrated that occurs in the hole 113 portion when the switches 115 are turned ON.

FIG. 10 illustrates a current distribution corresponding to the above (2. The switches 115 on the left side are turned ON, refer to FIGS. 5A and 58). All the switches 115 on the left side of the center column in the column direction of the conductive plate 110 are turned ON, and the holes 113 positioned in the columns 5A, 5B, and 5C are connected in the row direction. At this time, a strong current (=antinode) is applied to a portion of the switches 115 that are turned ON, and it can be confirmed that a current of one wavelength is applied to one round of the hole 113 at the center (column 5A).

The radio waves emitted by the dipole antenna 150 cause a strong current in the portion of the hole 113 closed with (about) one wavelength by turning ON the switch 115 on the conductive plate 110, and the directionality changes by being attracted to the direction of the hole 113.

FIG. 11 illustrates a current distribution in each phase when the switches 115 on the left side are turned ON. At a phase=50 degrees in FIG. 11(a), it is illustrated that a current is applied to the hole 113 at the center (column 5A) in the column direction. At a phase=100 degrees in FIG. 11(b) and a phase=150 degrees in FIG. 11(c), it is illustrated that a current is applied to the holes 113 at the center and on the left side (columns 5A and 5B) in the column direction. At a phase=200 degrees in FIG. 11(d), it is illustrated that a current is applied to the holes 113 at the left end (column 5C) in the column direction.

As illustrated in FIG. 11, the current flows from the hole 113 (small hole 113a in FIG. 1) at the center (column 5A)→the holes 113 (middle hole 113b in FIG. 1) on the left side (column 5B)→the holes 113 (large hole 113c in FIG. 1) at the left end (column 5C) and forms the current distribution corresponding to FIG. 10. As a result, with each current, the radio waves from the dipole antenna 150 are strengthened on the left side of the conductive plate 110 and are combined, and the directionality of the radio waves can be controlled to the left side.

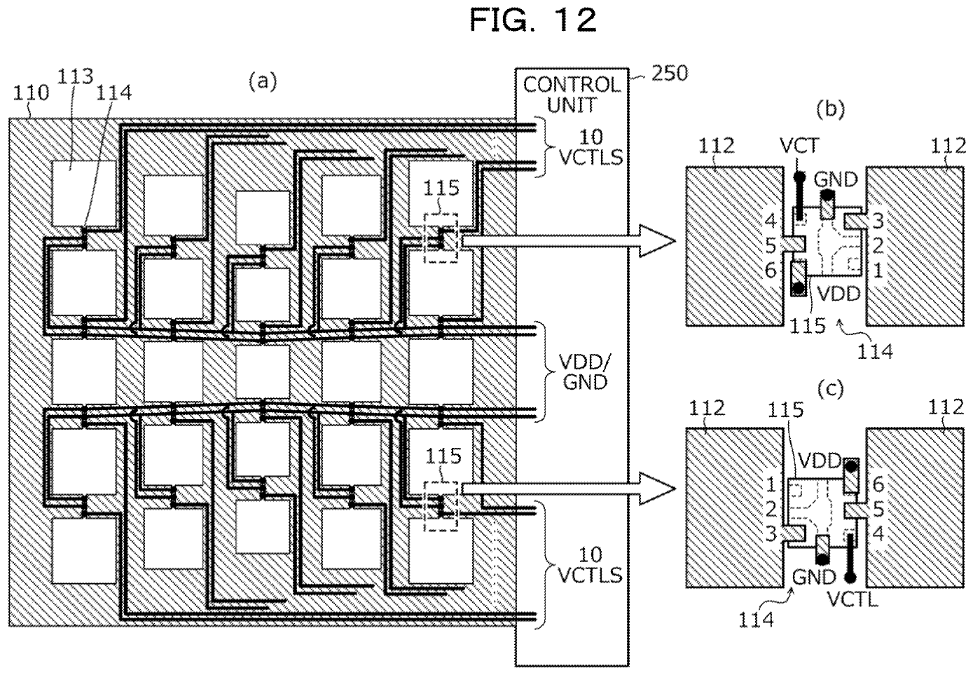

FIG. 12 is a diagram illustrating a switch drive line example of the electromagnetic wave control device according to the embodiment. As illustrated in FIG. 12(a), the switches 115 are respectively arranged in the slits 114 of the conductive plate 110. On the conductive plate 110, one control line VCTL and one power supply line VDD/GND are formed between the control unit 250 and each switch 115.

In the example in FIG. 12(a), 10 control lines VCTL and one power supply line VDD/GND are branched and connected to 10 switches 115 in the upper half and 10 switches 115 in the lower half. By wiring the control lines VCTL and the power supply line VDD/GND, for example, on a surface (rear surface) different from a surface (front surface) of the conductor 112 of the conductive plate 110, it is possible to reduce an effect on the radio waves.

Furthermore, each of FIGS. 12(b) and 12(c) is an arrangement example of the switches 115. It is possible to use the switches 115 in terminal arrangement in FIG. 12(b) or 12(c) according to arrangement positions of a pair of conductors 112 facing across the slit 114 and drawing directions of the control lines VCTL and the power supply line VDD/GND.

For example, in FIG. 12(b), the VCTL and the GND are drawn upward, and the VDD is drawn downward. The VCTL, the GND, and the VDD can be used for the 10 switches 115 in the upper half of FIG. 12(a). Furthermore, in FIG. 12(c), the VCTL and the GND are drawn downward, and the VDD is drawn upward. The VCTL, the GND, and the VDD can be used for the 10 switches 115 in the lower half of FIG. 12(a).

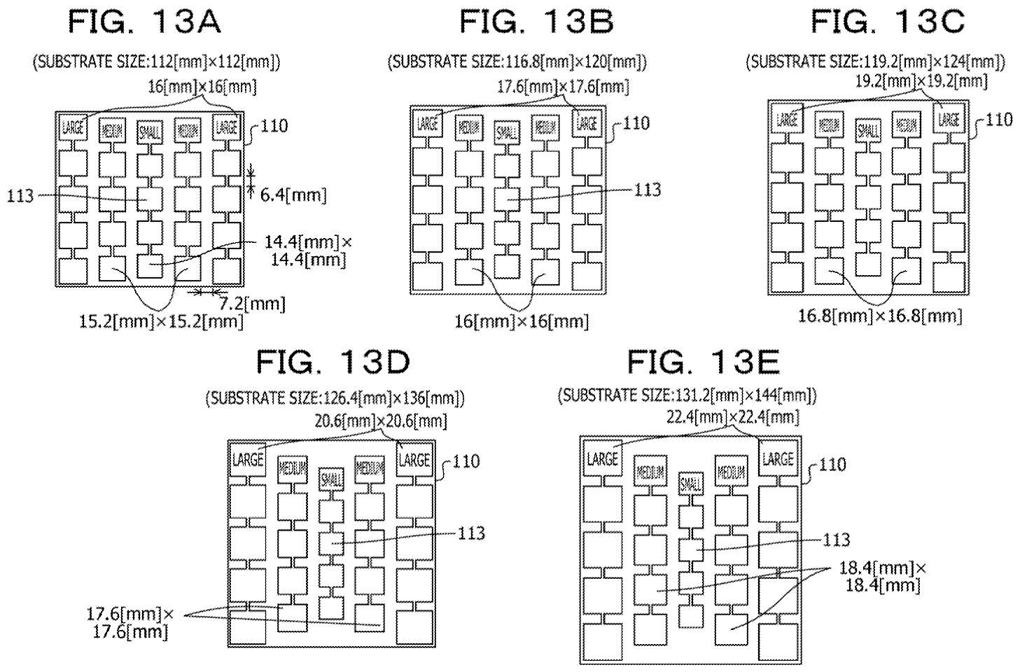

FIGS. 13A to 13E are a diagram illustrating an example of a change in a size of the hole formed in the conductive plate of the electromagnetic wave control device according to the embodiment. In A to E of FIGS. 13A to 13E, it is assumed that all the small holes 113a (14.4 mm×14.4 mm, refer to FIG. 1) arranged at the center in the columns have a common size. Furthermore, the slit 114 between the holes 113 has a common size (6.4 mm). Furthermore, an interval between the holes 113 adjacent in the column direction is 7.2 mm.

A pattern 2 in FIG. 13B indicates the reference size described above (refer to FIG. 1), and includes the medium holes 113b (16 mm×16 mm) and the large holes 113c (17.6 mm×17.6 mm). In this case, an overall size of the conductive plate 110 is 116.8 mm×120 mm.

In a pattern 1 in FIG. 13A, the sizes of the middle and large holes 113b and 113c are formed to be slightly smaller (−0.8 mm, −1.6 mm) than those in FIG. 13B to be the reference. The medium hole 113b has a size of 15.2 mm×15.2 mm, and the large hole 113c has a size of 17.6 mm×17.6 mm. In this case, an overall size of the conductive plate 110 is 112 mm×112 mm.

In a pattern 3 in FIG. 13C, the sizes of the middle and large holes 113b and 113c are formed to be slightly larger (+0.8 mm, +1.6 mm) than those in FIG. 13B to be the reference. The medium hole 113b has a size of 16.8 mm×16.8 mm, and the large hole 113c has a size of 19.2 mm×19.2 mm. In this case, an overall size of the conductive plate 110 is 119.2 mm×124 mm.

In a pattern 4 in FIG. 13D, the sizes of the middle and large holes 113b and 113c are formed to be larger (+1.6 mm, +3.0 mm) than those in FIG. 13B to be the reference. The medium hole 113b has a size of 17.6 mm×17.6 mm, and the large hole 113c has a size of 20.6 mm×20.6 mm. In this case, an overall size of the conductive plate 110 is 126.4 mm×136 mm.

In a pattern 5 in FIG. 13E, the sizes of the middle and large holes 113b and 113c are formed to be larger (+2.4 mm, +4.8 mm) than those in FIG. 13B to be the reference. The medium hole 113b has a size of 18.4 mm×18.4 mm, and the large hole 113c has a size of 22.4 mm×22.4 mm. In this case, an overall size of the conductive plate 110 is 131.2 mm×144 mm.

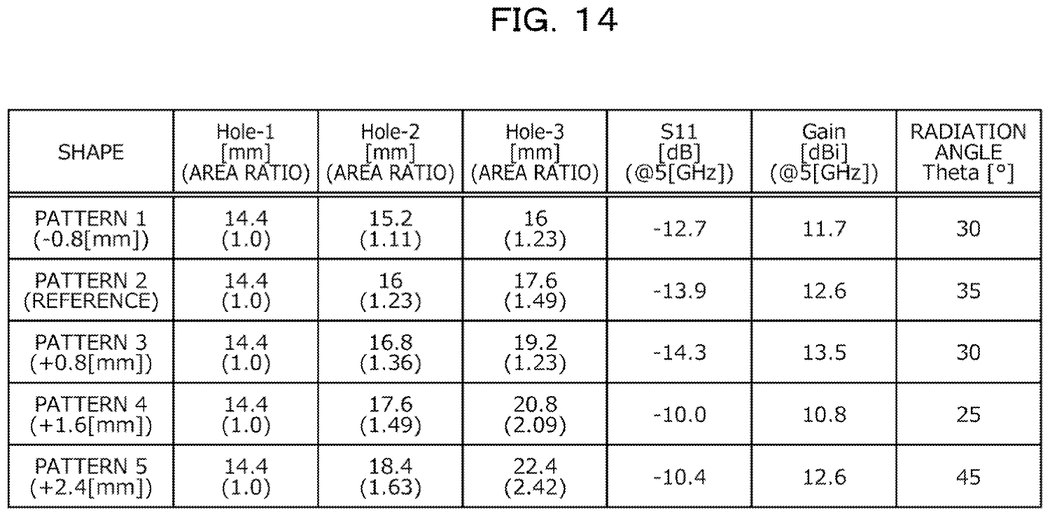

FIG. 14 is a table illustrating a change in characteristics at the time when the size of the hole formed in the conductive plate of the electromagnetic wave control device according to the embodiment is changed. In the state where the switches 115 on the left side of the conductive plate 110 are turned ON (refer to FIGS. 5A and 51), each analysis result corresponding to each of the patterns 1 to 5 in FIGS. 13A to 13E is Illustrated. A communication frequency is 5 GHz.

On the horizontal axis of FIG. 14, the size [mm] of the hole 113 of each of the patterns 1 to 5 and an area ratio, S11 characteristics (reflection characteristic [dB]), an absolute gain Gain [dBi], and a radiation angle (Theta [°]) are illustrated. The area ratio is a ratio of areas of the medium hole 113b and the large hole 113c when the small hole 113a is set to one. The radiation angle indicates a direction (directionality) of the radio waves emitted by the electromagnetic wave control device 100.

In the analysis result illustrated in FIG. 14, both of the S11 characteristics and the characteristics of the absolute gain do not characteristically change even if the size of the hole 113 is changed. Furthermore, in the patterns 1 to 4, the radiation angle has a directionality of approximately 30° to the lower side, and the radiation angle is widened to 45° in the pattern 5. Furthermore, a radiation angle 35° in the pattern 2 is almost equal (Gain=12.5 dBi) to an absolute gain (Gain) of Theta=30° and Phi=180°.

Furthermore, a radiation angle 35° in the pattern 2 is almost equal (Gain=12.5 dBi) to an absolute gain (Gain) of Theta=30° and Phi=180°. Furthermore, the radiation angle 45° in the pattern 5 is almost equal (Gain=10.5 dBi) to an absolute gain (Gain) of Theta=30° and Phi=180°.

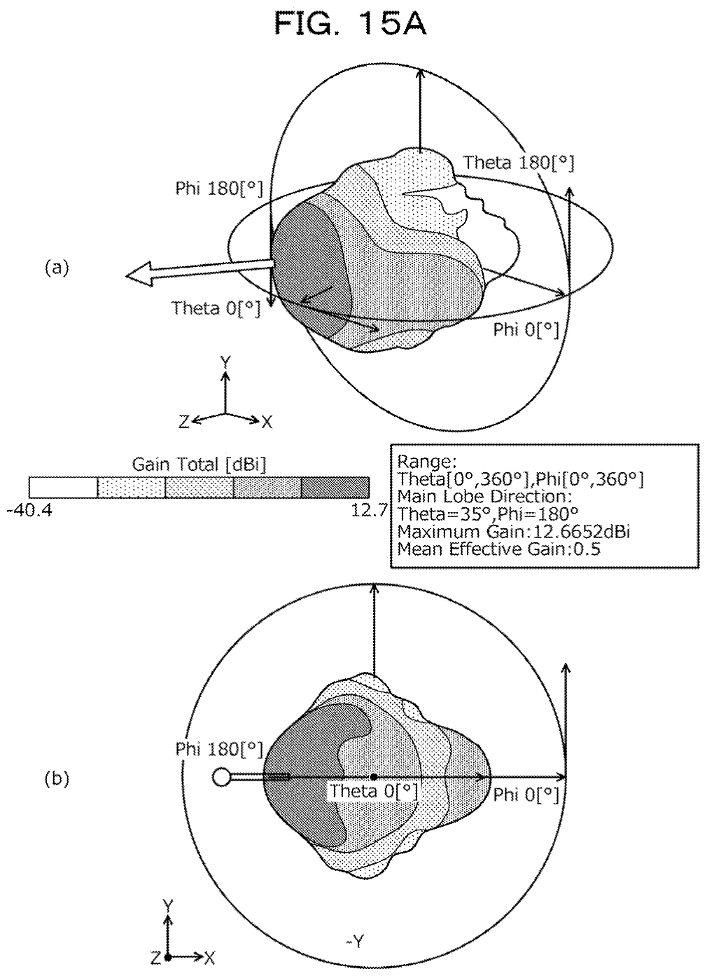

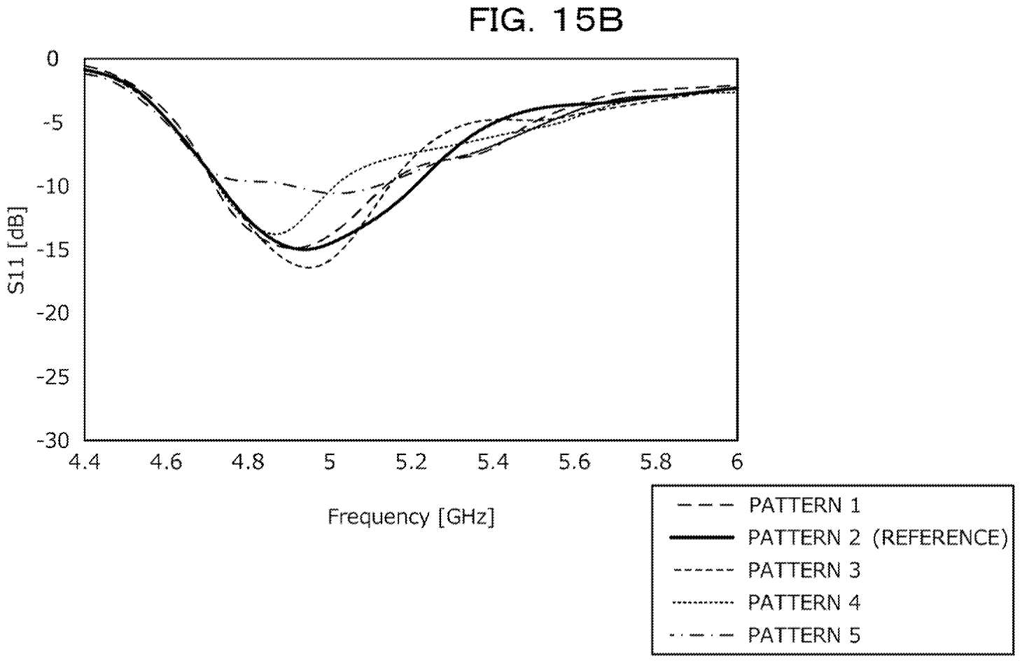

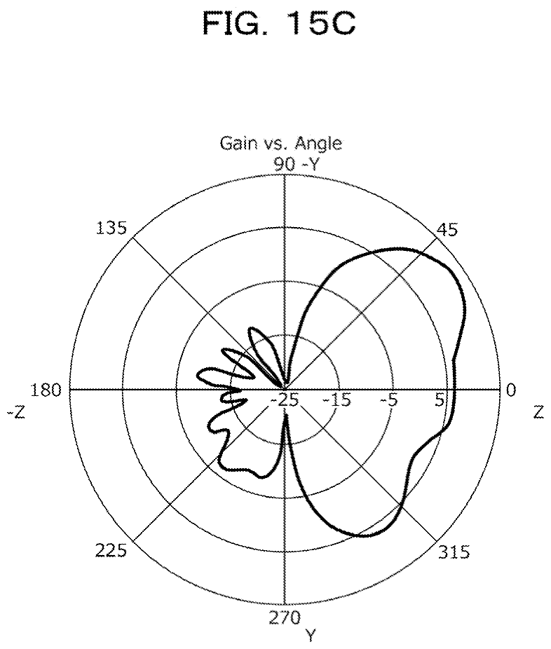

FIGS. 15A to 15C are diagrams illustrating simulation results of various characteristics at the time when the hole of the electromagnetic wave control device according to the embodiment is set according to the pattern 2 that is a reference. An example is illustrated in which the holes 113 are set according to the above-described pattern 2 (refer to FIG. 13B), the small hole 113a has a size of 14.4 mm square, the medium hole 113b has a size of 16 mm square, and the large hole 113c has a size of 17.6 mm square.

FIG. 15A(a) illustrates directional characteristics three-dimensionally formed with the X, Y, and Z axes, and FIG. 15A(b) illustrates the directional characteristics planarized on the X and Y axes. As illustrated in these drawings, the electric field has a strong directionality in the direction of 35 degrees to the left side of the conductive plate 110.

FIG. 158 illustrates S11 characteristics of each of the patterns 1 to 5 including the pattern 2. The horizontal axis indicates a frequency (GHz), and the vertical axis indicates S11 characteristics. In this way, the patterns 1 to 5 have substantially similar S11 characteristics. Only in the pattern 5, the S11 characteristics are slightly deteriorated. FIG. 15C illustrates directional characteristics on the X and Y axis plane and has a directionality to the direction of 35°.

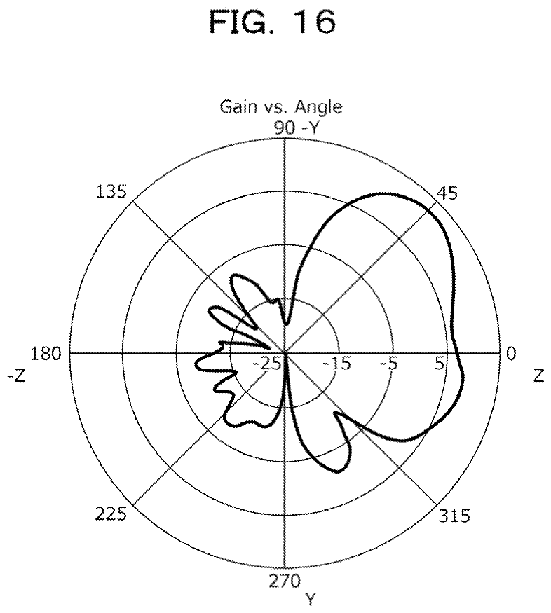

FIG. 16 is a diagram illustrating a simulation result of a directionality at the time when the hole of the electromagnetic wave control device according to the embodiment is set according to the pattern 5. FIG. 16 illustrates directional characteristics on the X and Y axis plane in the pattern 5 (refer to FIG. 13E) and has a directionality in a direction of 45°.

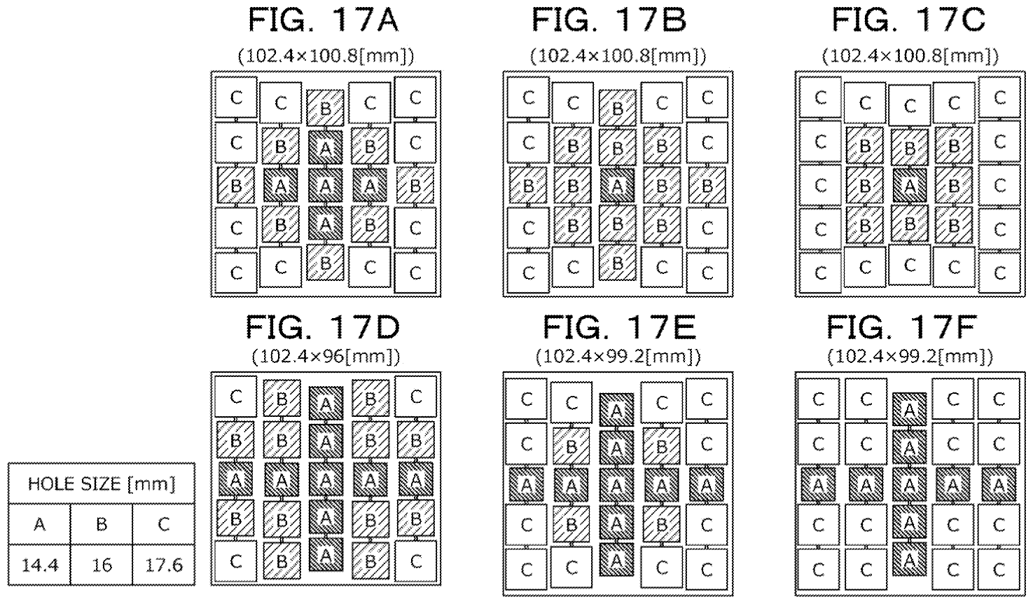

FIGS. 17A to 17F is a diagram illustrating various examples of arrangement of the holes of the electromagnetic wave control device according to the embodiment. FIGS. 17A to 17F are examples in which the arrangement of the pattern 2 to be the reference described above is modified. The small holes 113a (14.4 mm square), the medium holes 113b (16 mm square), and the large holes 113c (17.6 mm square) are concentrically arranged with respect to the center of the conductive plate 110.

In a pattern 2a in FIG. 17A, five small holes A (113a) are arranged in a cross-like shape from the center, eight medium holes B (113b) are arranged therearound, and twelve large holes C (113c) are arranged therearound. In a pattern 2b in FIG. 178, a single small hole A (113a) is arranged at the center, medium holes B (113b) are arranged therearound, and all the holes in the column direction at the center position are the medium holes B (113b) (twelve holes in total). Twelve large holes C (113c) are arranged therearound. In a pattern 2c in FIG. 17C, a single small hole A (113a) is at the center, eight medium holes B (113b) are arranged therearound, and sixteen large holes C (113c) are arranged therearound. In a case of these patterns 2a to 2c, the size of the conductive plate 110 is 102.4 mm×100.8 mm.

In a pattern 2d in FIG. 17D, nine small holes A (113a) are arranged in a cross-like shape from the center to the end, twelve medium holes B (113b) are arranged therearound, and four large holes C (113c) are arranged therearound. In a case of this pattern 2d, the size of the conductive plate 110 is 102.4 mm×96 mm. In a pattern 2e in FIG. 17E, nine small holes A (113a) are arranged in a cross-like shape from the center to the end, four medium holes B (113b) are arranged therearound, and twelve large holes C (113c) are arranged therearound. In a case of this pattern 2e, the size of the conductive plate 110 is 102.4 mm×99.2 mm. In a pattern 2f in FIG. 17F, nine small holes A (113a) are arranged in a cross-like shape from the center to the end, and sixteen large holes C (113c) are arranged without providing medium holes B (113b) around the small holes A. In a case of this pattern 2f, the size of the conductive plate 110 is 102.4 mm×99.2 mm.

In these examples, in which the arrangement is modified, illustrated in FIGS. 17A to 17F, various characteristics are slightly deteriorated than those of the arrangement example of the pattern 2 described above. However, the emission direction of the dipole antenna 150 can be similarly controlled. In this way, regarding the holes 113 formed on the conductive plate 110, by arranging the small holes 113a at the center, arranging the medium holes 113b therearound (outer side of small holes 113a), and arranging the large holes 113c therearound (outer side of medium holes 113b), it is possible to obtain the similar characteristics in any case.

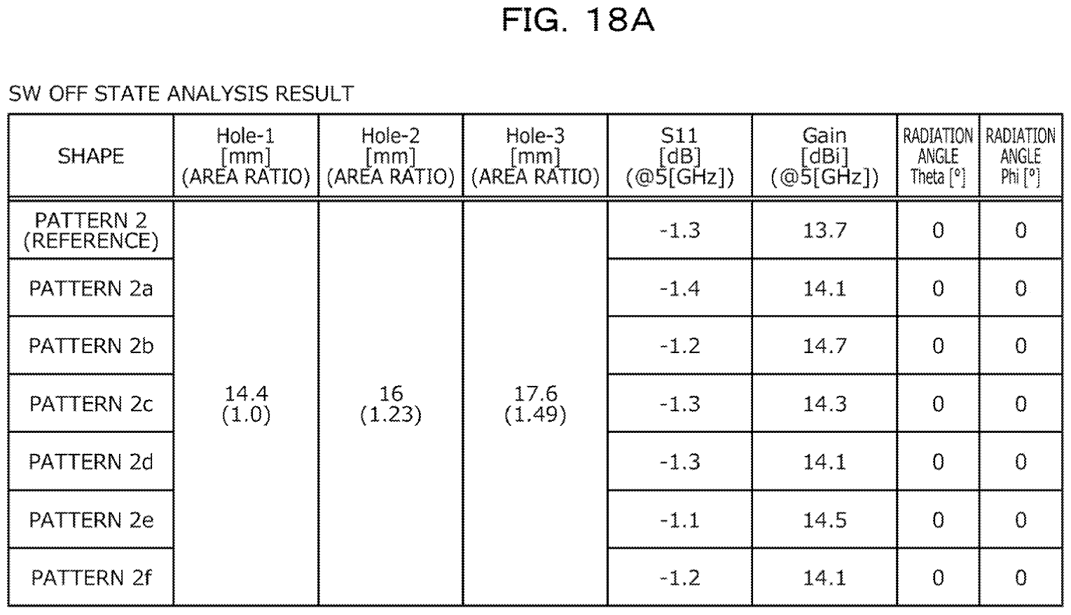

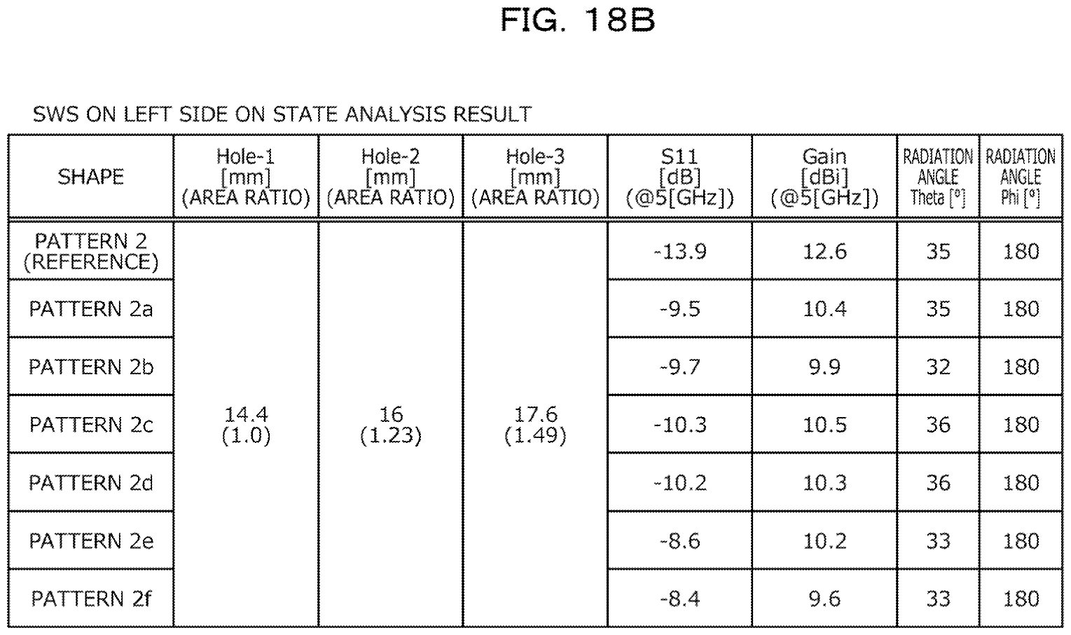

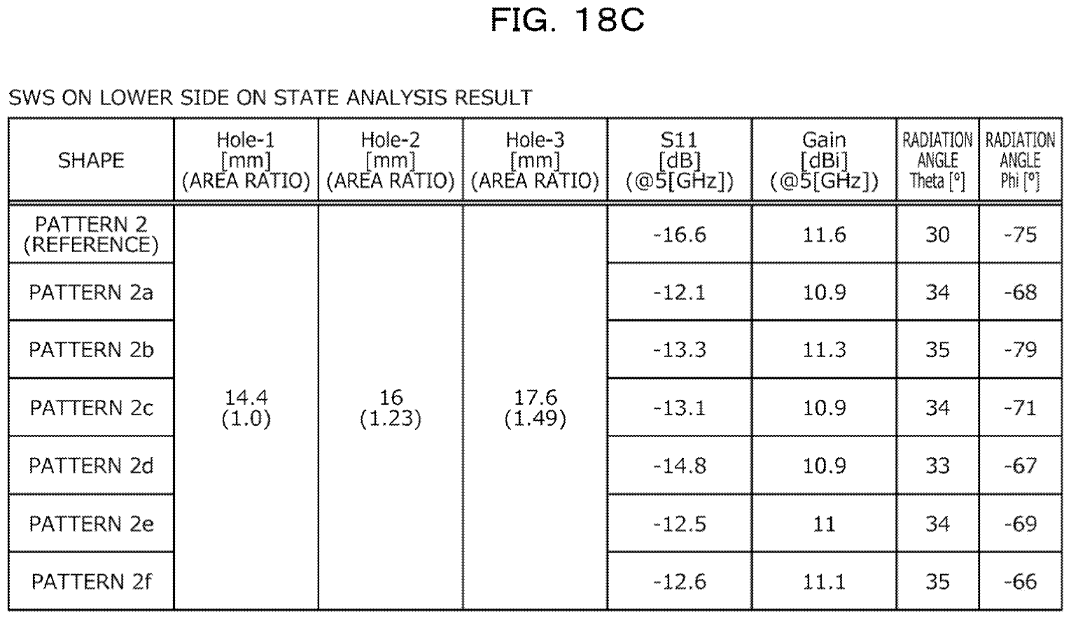

FIGS. 18A to 18C are diagrams illustrating various characteristics corresponding to the various examples of the arrangement of the holes of the electromagnetic wave control device according to the embodiment. Various characteristics of the pattern 2 (FIG. 13B) to be a reference and each of the patterns 2a to 2f illustrated in FIGS. 17A to 17F are illustrated. On the horizontal axis of FIGS. 18A to 18C, the size of the hole 113 [mm], the area ratio, the S11 characteristics (reflection characteristics [dB]), the absolute gain Gain [dBi], the radiation angle ([Theta [° ]), and the radiation angle (Phi [° ]) of each of the patterns 2 and 2a to 2f at the time when the communication frequency is 5 GHz are illustrated.

FIG. 18A illustrates various characteristics in a state where all the switches 115 are turned OFF (corresponding to FIGS. 4A and 4B). FIG. 18B illustrates various characteristics in a state where the switches 115 on the left side of the conductive plate 110 are turned ON (corresponding to FIGS. 5A and 51). FIG. 18C illustrates various characteristics in a state where the switches 115 on the lower side of the conductive plate 110 are turned ON (corresponding to FIGS. 6A and 68).

As illustrated in these drawings, regardless of the switching state of the switch 115, various characteristics of the pattern 2 to be the reference and various characteristics of the patterns 2a to 2f in which the arrangement positions of the holes 113 are changed are almost the same.

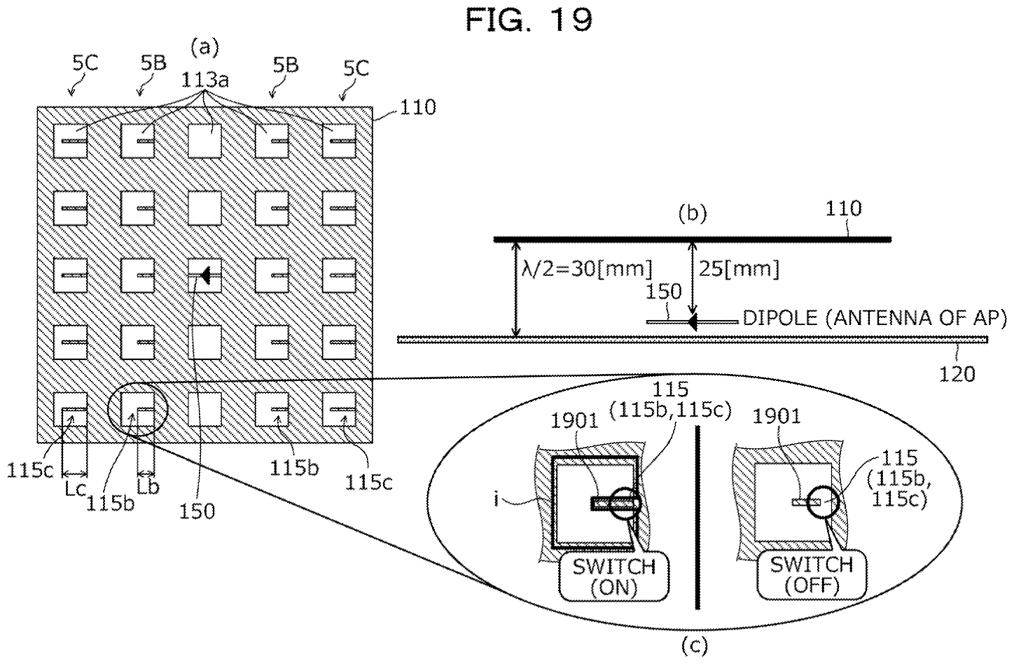

FIG. 19 is a diagram illustrating a modification of the switch of the electromagnetic wave control device according to the embodiment. FIG. 19(a) is a front view, FIG. 19(b) is a side view, and FIG. 19(c) is a partially enlarged view of FIG. 19(a).

As illustrated in FIG. 19(a), it is assumed that the hole provided in the conductive plate 110 be the small hole 113a described above. Then, the switch 115 is provided in the hole 113a. A structure viewed from the side illustrated in FIG. 19(b) is similar to the above (refer to FIG. 1(b)).

Then, the switch 115 is not provided in the hole 113a at the center in the column direction, and the inner edge length of the hole 113a in this single central column is set to about one wavelength. Then, a switch 115b that is slightly projected and has a predetermined length Lb is provided in the hole 113a in the column 5B that is adjacent to and outside of the hole 113a at the center. Furthermore, in the hole 113a in the column 5C on the outer side, a long switch 115c that is projected and has a predetermined length Lc longer than the switch 115b is provided.

Particularly, as illustrated in FIG. 1(c), a linear conductor (metal element) 1901 having a predetermined length is formed in the hole 113a. A length of the linear conductor 1901 is set to be Lb in the column 58 and is set to be Lc (Lb<Lc) in the column 5C, and the hole 113 in the column on the outer side is set to be longer. As a result, when the switches 115 (115b and 115c) are turned ON, a part of the outer periphery of the hole 113 is conductively connected to the conductor 1901 via the switches 115 (115b and 115c).

At this time, if the switch 115b in the column 5B is turned ON, a current i flows around the outer periphery of the hole 113a in the column 5B, and a part of the current i flows in a portion of the conductor 1901 having the length Lb via the switch 115b. A path through which the current i flows has an inner edge length equal to or more than one wavelength. Similarly, if the switch 115c in the column 5C is turned ON, the current i flows around the outer periphery of the hole 113a in the column 5C, and a part of the current i flows in a portion of the conductor 1901 having the length Lc via the switch 115c. A path through which the current i flows has an inner edge length equal to or more than one wavelength and is even longer than the column 5B.

According to the switch structure illustrated in FIG. 19, by controlling switching of the switch 115, it is possible to switch formation of the current path to the linear conductor 1901 in the hole 113a. In other words, for example, unlike the switch 115 described with reference to FIG. 1 or the like, the structure in which the holes 113 are connected by the slit 114 can be no longer required. By switching the single switch 115 among the switches 115 provided in the respective holes 113a, it is possible to select one corresponding hole 113a.

Note that, also in the configuration example in FIG. 19, by wiring the control lines VCTL and the power supply line VDD/GND used to control switching of the switch 115, on a surface (rear surface) different from a surface (front surface) of the conductor 112 of the conductive plate 110, it is possible to reduce an effect on the radio waves.

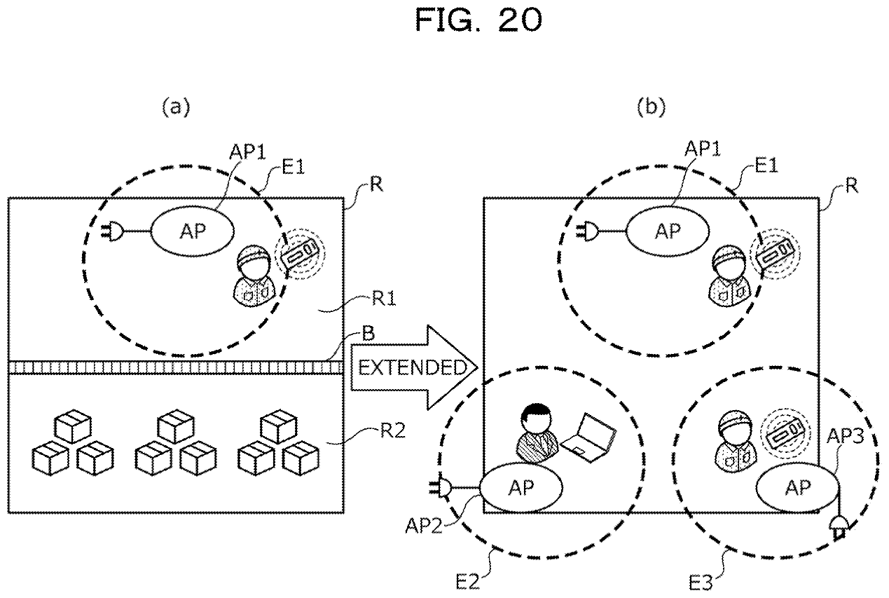

FIG. 20 is a diagram for explaining an application example of the electromagnetic wave control device according to the embodiment. By using the electromagnetic wave control device 100 described in the embodiment, for example, it is possible to easily change a communication range in a predetermined region R.

FIG. 20(a) illustrates a state before a layout of the predetermined region R is changed. For example, it is assumed that the predetermined region R be divided into two regions R1 and R2 with a wall or a partition plate B. In the region R1, for example, an AP 1 of a wireless LAN can communicate with a terminal or the like within a communication range E1. The region R2 is, for example, a warehouse.

Thereafter, as illustrated in FIG. 20(b), it is assumed that the wall or the partition plate B of the predetermined region R be removed and a layout of a part of the region R2 be changed to an office or a work lane. At this time, in the single predetermined region R, the communication range E1 of the AP 1, a communication range E2 of an AP 2, and a communication range E3 of an AP 3 are arranged without providing the walls or the partition plates B. In this case, with the existing APs (AP 1 to AP 3), it is difficult to arrange the communication ranges E1 to E3 without interfering with each other. With the existing APs, the communication ranges E1 to E3 illustrated in FIG. 20(b) overlap each other.

On the other hand, by using the electromagnetic wave control device 100 according to the embodiment, it is possible to control the directionality of the radio waves emitted by the APs (AP 1 to AP 3). As illustrated in FIG. 20(b), the communication ranges E1 to E3 can be divided. In this way, according to the embodiment, the directionality can be controlled for each AP. Therefore, it is possible to set the necessary communication ranges E1 to E3 coping with expansion or integration of departments within the predetermined region R. At this time, if each of the communication ranges E1 to E3 does not interfere with the other communication ranges E1 to E3, it is possible to maintain security even if a method such as encryption different for each communication range (AP) is no longer required.

In the electromagnetic wave control device according to the embodiment described above, the reflector is arranged on the side opposite to the radio wave emission side of the antenna, and the conductor plate on which the conductor is formed is arranged on the radio wave emission side of the antenna, and the directionality of the radio waves emitted by the antenna is controlled by the conductive plate. The hole at the center on the conductive plate has an inner edge length corresponding to one wavelength and resonates with radio waves so as to generate a strong current. Furthermore, the inner edge length of the hole is provided to be gradually longer toward the hole on the outer side with respect to the hole at the center. As a result, the directionality of the radio wave can be controlled to be directed to a direction in which the plurality of holes that has these inner edge lengths and is closed is formed.

Furthermore, by connecting the plurality of holes with each other by the slit and arranging the slit in a direction orthogonal to the main polarized wave of the antenna, the directionality can be changed.

Furthermore, by providing the switch that conductively connects or disconnects the slit between the plurality of adjacent holes in a slit portion, a directionality in an optional direction can be obtained by performing switching control for turning ON/OFF the switch. As a result, after the electromagnetic wave control device is installed at a fixed position, the directionality can be changed to an optional direction without changing a position such as an angle. In other words, for example, the directionality of the radio wave emitted by the antenna can be controlled in a state where the electromagnetic wave control device is fixed and arranged.

Furthermore, it is preferable to set the lengths of the hole and the slit so that the inner edge length including the hole positioned at the center and the slit at the time of being conductively connected to the hole at the center is one wavelength. As a result, a strong current can be generated by resonance with respect to the radio wave, and it is possible to obtain a directionality in a desired direction.

Furthermore, as other components of the electromagnetic wave control device, the reflector similar to that described above and a conductor plate are included. Then, the conductor plate may have a configuration in which a plurality of holes formed by opening the conductor is provided in a grid pattern, the conductor plate has an inner edge length, with which the hole resonates, corresponding to one wavelength of a communication wavelength, a linear conductor with a predetermined length is included in the hole, and a switch that conductively connects or disconnects the linear conductor with the hole is included. With this configuration, the slit described above can be made unnecessary, and the sizes of all the holes can be the same, and switching of the single hole can be controlled by the single switch.

Furthermore, the control line (VCTL) that drives a switch and the power supply line (VDD/GND) may be formed on a surface different from the surface where the conductor is formed. As a result, an effect on the radio waves can be reduced.

Furthermore, the hole can have any shape such as a square, a circle, a polygon, or the like, and it is sufficient to appropriately select a shape according a space on the conductive plate or the like.

Furthermore, a device of the access point or an antenna drawn from the device of the access point can be arranged between the reflector and the conductive plate. This makes it possible to control the directionality using a general-purpose AP.

Furthermore, the control unit that controls the switch is included, and the control unit performs control to turn ON the switch of the hole so as to flow a strong current along the inner edge of the hole corresponding to the switch. This makes it possible to obtain the directionality to the direction of this hole. The control unit may be formed on the printed circuit board same as the printed circuit board where the conductive plate is formed, and in addition, may be arranged at a position different from the conductive plate.

Furthermore, the control unit may store and hold setting information in which a directivity direction of the radio wave and a switch switching state corresponding to this directivity direction are associated as a plurality of patterns for each of a plurality of directivity directions in a storage unit. Then, the control unit can read the setting information, which is stored in the storage unit, in correspondence with a directivity direction requested from a user or the like and can control switching of the corresponding switch. As a result, the directionality in each direction can be obtained for each pattern.

Furthermore, an electromagnetic wave control system according to the embodiment can include the electromagnetic wave control device described above, an access point including an antenna, and a cover that contains the access point and the electromagnetic wave control device. The cover can be easily attached to a wall, a ceiling, or the like constructing a predetermined communication area. Here, because the directionality in the communication area is controlled, for example, when the terminal is positioned in the communication area, for example, the terminal can also communicate with the access point.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electromagnetic wave control device that controls a directionality of radio waves emitted by an antenna, the electromagnetic wave control device comprising:
a reflector arranged on a side opposite to an emission side of the radio waves of the antenna; and
a conductor plate that is arranged on the emission side of the radio waves of the antenna and on which a conductor is formed, wherein
in the conductor plate,
a plurality of holes formed by opening the conductor is provided in a grid pattern, and has an inner edge length with which the hole positioned at the center resonates in correspondence with one wavelength of a communication wavelength, and
the inner edge length of the hole is formed to be longer as going outward from the center.

2. The electromagnetic wave control device according to claim 1, further comprising:
a slit configured to connect the plurality of holes to each other, wherein
the slit is arranged in a direction orthogonal to a main polarized wave of the antenna.

3. The electromagnetic wave control device according to claim 2, further comprising:
a switch configured to conductively connect or disconnect the slit between the plurality of adjacent holes in a portion of the slit.

4. The electromagnetic wave control device according to claim 2, wherein
lengths of the hole and the slit are set so that the inner edge length that includes the hole positioned at the center and the slit at the time of being conductively connected to the hole is one wavelength.

5. An electromagnetic wave control device that controls a directionality of radio waves emitted by an antenna, the electromagnetic wave control device comprising:
a reflector arranged on a side opposite to an emission side of the radio waves of the antenna; and
a conductor plate that is arranged on the emission side of the radio waves of the antenna and on which a conductor is formed, wherein
in the conductor plate,
a plurality of holes formed by opening the conductor is provided in a grid pattern, and has an inner edge length with which the hole resonates in correspondence with one wavelength of a communication wavelength, and
a linear conductor with a predetermined length is included in the hole, and
a switch that conductively connects or disconnects the linear conductor with the hole is included.

6. The electromagnetic wave control device according to claim 5, wherein
a distance between the reflector and the conductive plate is a half-wave length.

7. The electromagnetic wave control device according to claim 5, wherein
a control line that drives the switch and a power supply line are formed on a surface different from a surface on which the conductor is formed.

8. The electromagnetic wave control device according to claim 5, wherein
the hole is a square, a circle, or a polygon.

9. The electromagnetic wave control device according to claim 5, wherein
a device of an access point or an antenna drawn from the device of the access point is arranged between the reflector and the conductive plate.

10. The electromagnetic wave control device according to claim 5, further comprising:
a control unit configured to control the switch, wherein
the control unit performs control to turn ON the switch of the hole so as to flow a strong current along an inner edge of the hole that corresponds to the switch and obtain a directionality to a direction of the hole.

11. The electromagnetic wave control device according to claim 10, wherein
the control unit
stores and holds setting information in which a directivity direction of the radio wave and a switching state of the switch that corresponds to the directivity direction are associated as a plurality of patterns for each of a plurality of directivity directions, and
reads the stored setting information in correspondence with a requested directivity direction and controls switching of the switch.
